(19) United States
(12) Patent Application Publication
(10) Pub. No.: US 2014/0172648 A1
(43) Pub. Date: Jun. 19, 2014

(54) CONSUMER ACTIVITY MANAGEMENT

(71) Applicant: Raimund Gross, Walldorf (DE)

(72) Inventor: Raimund Gross, Walldorf (DE)

(21) Appl. No.: 13/720,112

(22) Filed: Dec. 19, 2012

(51) Int. Cl. G06Q 30/06

(52) U.S. Cl. CPC G06Q 30/0641
USPC 705/27.1

(57) ABSTRACT

In accordance with aspects of the disclosure, a system and methods are provided for managing consumer activity. The systems and methods may include monitoring physical shopping activities of a user by receiving information from collaborating devices in a physical retailer store including information related to products available in physical retailer store. The systems and methods may include defining a relationship between products of a shopping list for the user and the products available in the physical retailer store corresponding to the products of the shopping list for the user. The systems and methods may include linking the relationship to a context for the user and presenting an overview to the user via the user device including information related to the linking of the relationship to the context for the user.

### TECHNICAL FIELD

The present description relates to computer-based techniques for consumer activity management.

### BACKGROUND

Presently, consumers may be confronted with a gap between an analog shopping experience and digital information related to shopping. For some consumers, shopping lists written on paper may be difficult to keep track of during shopping, and for other consumers, shopping lists stored in digital format with clumsy applications may not support any relevant references to shopping experiences. Generally, there may not be helpful relationships provided between items on a shopping list and items available in a store, except in the mind of the consumer.

Typically, consumers may not have knowledge about which stores have some or most items on a shopping list in available inventory, where to find items on a shopping list in a specific store, which items of a specific store or brand is relevant for the consumer when generic item descriptions are on the shopping list, and which incentive information may be relevant to items on a shopping list, such as promotions, cash-back offers, loyalty benefits, membership gratifications, etc.

As such, there currently exists a need to assist consumers when shopping for items on a shopping list.

### SUMMARY

In accordance with aspects of the disclosure, a computer system may be provided for consumer activity management including instructions recorded on a non-transitory computer-readable medium and executable by at least one processor. The system may include an interface handler configured to cause the at least one processor to receive information from a user via a user device including a shopping list of one or more products intended for purchase by the user, a resource handler configured to cause the at least one processor to retrieve information from one or more resources including information related to the one or more products of the shopping list, and a context handler configured to cause the at least one processor to derive and maintain a context for the user based on the information received from the user device and the information retrieved from the one or more resources. The system may include an activity manager configured to cause the at least one processor to manage a shopping experience for the user by monitoring one or more physical shopping activities of the user by receiving information from one or more collaborating devices in at least one physical retailer store including information related to one or more products available in the at least one physical retailer store, defining a relationship between the one or more products of the shopping list and the one or more products available in the at least one physical retailer store corresponding to the one or more products of the shopping list, linking the relationship to the context for the user, and presenting an overview to the user via the user device including information related to the linking of the relationship to the context for the user.

In accordance with aspects of the disclosure, a computer-implemented method may be provided for consumer activity management. The method may include receiving information from a user via a user device including a shopping list of one or more products intended for purchase by the user, retrieving information from one or more resources including information related to the one or more products of the shopping list, and deriving and maintaining a context for the user based on the information received from the user device and the information retrieved from the one or more resources. The method may include managing a shopping experience for the user by monitoring one or more physical shopping activities of the user by receiving information from one or more collaborating devices in at least one physical retailer store including information related to one or more products available in the at least one physical retailer store, defining a relationship between the one or more products of the shopping list and the one or more products available in the at least one physical retailer store corresponding to the one or more products of the shopping list, linking the relationship to the context for the user, and presenting an overview to the user via the user device including information related to the linking of the relationship to the context for the user.

In accordance with aspects of the disclosure, a computer program product may be provided for consumer activity management, wherein the computer program product may be tangibly embodied on a computer-readable storage medium and includes instructions that, when executed by at least one processor, are configured to manage consumer activity. The instructions, when executed by the at least one processor, may be configured to receive information from a user via a user device including a shopping list of one or more products intended for purchase by the user, retrieve information from one or more resources including information related to the one or more products of the shopping list, and derive and maintain a context for the user based on the information received from the user device and the information retrieved from the one or more resources. The instructions, when executed by the at least one processor, may be configured to manage a shopping experience for the user by monitoring one or more physical shopping activities of the user by receiving information from one or more collaborating devices in at least one physical retailer store including information related to one or more products available in the at least one physical retailer store, defining a relationship between the one or more products of the shopping list and the one or more products available in the at least one physical retailer store corresponding to the one or more products of the shopping list, linking the relationship to the context for the user, and presenting an overview to the user via the user device including information related to the linking of the relationship to the context for the user.

As provided herein, details of one or more implementations are set forth in the accompanying drawings and the description below. Other features will be apparent from the description and drawings, and from the claims.

### BRIEF DESCRIPTION OF THE DRAWINGS

FIG. 1 is a block diagram illustrating an example system for managing consumer activity, in accordance with aspects of the disclosure.

FIG. 2 is a block diagram illustrating an example process flow for managing consumer activity, in accordance with aspects of the disclosure.

FIG. 3 is a block diagram illustrating an example cloud-based system for managing consumer activity, in accordance with aspects of the disclosure.

FIG. 4 is a diagram illustrating an example overview for providing product location within a physical retailer store, in accordance with aspects of the disclosure.

FIG. 5 is a process flow illustrating an example method for managing consumer activity, in accordance with aspects of the disclosure.

FIG. 6 is a process flow illustrating another example method for managing consumer activity, in accordance with aspects of the disclosure.

### DETAILED DESCRIPTION

In accordance with aspects of the disclosure, a computer based system is provided for managing a shopping experience for a user including managing a mobile, cloud-based shopping list on behalf of the user that may connect to indoor navigation across one or more physical retailer stores. The system may be configured to provide a link between information related to physical shopping experiences of the user and information related to a context for the user. In various implementations, the user context and user context information may include any information relevant to a specific user, at a specific location, and at a specific time. The system may be further configured to define a relationship between one or more products of a shopping list for the user and one or more products available in the one or more physical retailer stores corresponding to the one or more products of the shopping list. The shopping list may include a list of one or more items, products, and/or services intended for purchase by the user. As such, the one or more products of the shopping list may refer and/or include one or more items and/or services intended for purchase by the user.

For instance, the system may provide the user with information related to the one or more physical retailer stores that have product availability for the one or more products of the shopping list based on the context for the user. The system may provide the user with information related to product location for where (in which aisle, in which shelf, in which position, etc.) to find or locate the one or more products of the shopping list intended for purchase in a specific physical retailer store. The system may provide the user with information related to product matches for a specific retailer store or brand that is relevant to the user when a generic product description for one or more products of the shopping list is provided. Further, the system may provide the user with any related incentive information that is relevant for intended purchases by the user, such as, for example, promotions, cash-back offers, loyalty benefits, membership gratifications, etc.

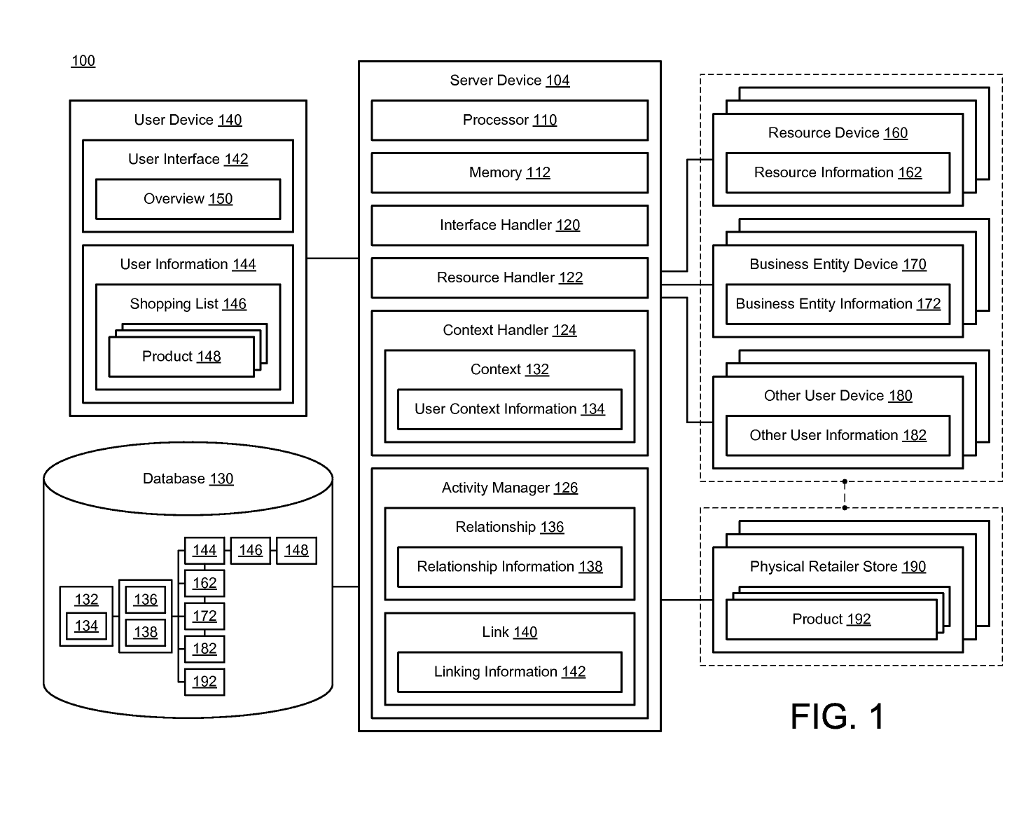

FIG. 1 is a block diagram illustrating an example system 100 for managing consumer activity, in accordance with aspects of the disclosure. The example system 100 may be used to manage a shopping experience for the user by monitoring one or more physical shopping activities of the user, defining relationships between products of a user shopping list and products available in physical retailer stores that correspond to products of the user shopping list, linking the defined relationships to a context for the user, and presenting an overview to the user via a user device including information related to the linking of the defined relationships to the context for the user.

In the example of FIG. 1, the system 100 comprises a computer system for implementing consumer activity management that may be associated with a computing device, such as a server device 104, thereby transforming the computing device into a special purpose machine designed to determine and implement transactional process(es), as described herein. In this sense, the server device 104 may include a server including any standard element(s), including at least one processor(s) 110, memory (e.g., a non-transitory computer-readable storage medium) 112, power, peripherals, and various other computing elements not specifically shown in FIG. 1. Further, the server device 104 may be implemented as a serving communication device adapted for interfacing with various system components (e.g., database 130, user device 140, resource devices 160, business entity devices 170, other user devices 180, and collaborating devices in physical retailer stores 190) and for wireless communication over one or more networks, such as, for example, one or more mobile communication networks including WLAN, Wi-Fi, wireless telecommunication networks, etc. and the Internet. In various examples, one or more other various elements of the system 100 that may be useful to implement the system 100 may be added or included, as would be apparent to one of ordinary skill in the art.

In an implementation, the user device 140 may be implemented using any appropriate combination of hardware and/or software configured for interfacing with a user including a user device, user interface (UI) device, user terminal, client device, or a customer device. For instance, the user device 140 may be implemented as a portable computing device, such as a laptop computer, a notebook computer, a tablet computer, and/or a personal digital assistant (PDA). In another instance, the user device 140 may be implemented as some other type of computing device adapted for interfacing with a user, such as, for example, a personal computer (PC). In still another example, the user device 140 may be implemented as a portable communication device (e.g., a mobile communication device including mobile cellular phone, a smart phone, a wireless phone, etc.) adapted for interfacing with a user and for wireless communication over one or more networks, such as, for example, one or more mobile communication networks including WLAN, Wi-Fi, wireless telecommunication networks, etc. and the Internet. In various examples, the user may be referred to as a consumer, a shopper, a client, etc.

As such, in the example of FIG. 1, the consumer activity management system 100 may include the server device 104 (e.g., a server) and instructions recorded on the non-transitory computer-readable medium 112 and executable by the at least one processor 110. In an implementation, the system 100 may be associated with a user and a the user device 140 (e.g., a computing device with a monitor or other display, such as a personal computer (PC), laptop, tablet, mobile phone, smart phone, etc.) that may be used to provide a user interface 142 (e.g., a user input interface including a graphical user interface (GUI), such as a browser or other user interface application). In an example, the user interface 142 may be used to receive various preferences from a user (i.e., consumer, shopper, client, etc.) for managing or utilizing the system 100. Further, the consumer activity management system 100 may include the user device 140 for providing output to the user, and the user device 140 may include the user interface 142 for receiving input from the user. For instance, information that may be received from the user may include user input information acquired from the user by the user device 140.

Referring to the example of FIG. 1, the server device 104 of the consumer activity management system 100 may include an interface handler 120 configured to cause the at least one processor 110 to receive user information 144 from a user via the user interface 142 of the user device 140 including a shopping list 146 of one or more items, products, and/or services 148 intended for purchase by the user. For instance, when a user plans a shopping trip or experience, the user may be inclined to create or generate a shopping list by listing one or more products in order of importance, need, time restraints, budget restraints, speed of locating and purchasing products, and obligations of the user when selecting products intended for purchase. The interface handler 120 may be configured to store the user information 144 including information related to the shopping list 146 and information related to the one or more products 148 of the shopping list 146 in a database 130, which may be internal or external to the server device 104. In various examples, information received from the user may include user input information acquired from the user by the user device 140.

In accordance with aspects of the disclosure, the systems and methods provided herein are configured to link an analog shopping activity to contextualized, digital information for managing a shopping experience of a user. For instance, a user may create or generate the shopping list 146 in a mobile application (e.g., user interface 142) on the user device 140 based on user information 144, such as user input including voice input, free text input, selection from existing product catalog, etc. The shopping list 146 may be created or generated without any relation to a specific retailer, specific store, specific brand, etc. Once a physical shopping activity is started, the user may manually assign the shopping list 146 to a specific physical retailer store or allow the server device 104 via the application to automatically assign the shopping list 146 to a physical retailer store when the user enters the physical retailer store. The shopping list 146 may include a list of one or more items, products, and/or services intended for purchase by the user, and as such, the one or more products of the shopping list may refer and/or include one or more items and/or services intended for purchase by the user.

In the example of FIG. 1, the server device 104 of the consumer activity management system 100 may include a resource handler 122 configured to cause the at least one processor 110 to retrieve information from one or more resources related to one or more resource devices 160 including resource information 162 related to the one or more products 148 of the shopping list 146. The resource handler 122 may be configured to store the resource information 162 including information related to the one or more products 148 of the shopping list 146 in the database 130. Further, the server device 104 may be implemented as a serving communication device adapted for interfacing with the one or more resource devices 160 and for wireless communication over one or more networks, such as, for example, one or more mobile communication networks including WLAN, Wi-Fi, wireless telecommunication networks, etc. and the Internet. In various implementations, the one or more resources devices 160 may include network computing devices, such as servers, computers, databases, or any other relevant computing devices configured for communication over a network including a wireless network.

In an example, the one or more resources and/or resource devices 160 may include one or more internal resources including locally stored information related to the one or more products of the shopping list 146. In another example, the one or more resources and/or resource devices 160 may include one or more external resources including remotely stored information related to the one or more products of the shopping list 146. The one or more resources and/or resource devices 160 may include information related to one or more of user purchase history, product availability, product information, product categories, product related alternatives, product promotions, product purchase incentives, retailer/store layout maps, product cataloging, and retailer/store acquired user information including loyalty benefits and user records.

In the example of FIG. 1, the server device 104 of the consumer activity management system 100 may include a context handler 124 configured to cause the at least one processor 110 to derive and maintain a context 132 for the user based on the user information 144 received from the user device 140 and the resource information 162 retrieved from the one or more resource devices 160. The context handler 124 may be configured to store the context 132 for the user including user context information 134 related to the context 132 for the user in the database 130. In various implementations, the user context information 134 may include any information relevant to a specific user, at a specific location, and at a specific time.

The context handler 124 may be configured to maintain the context 132 for the user by dynamically updating the information related to the user and dynamically updating the information related to the one or more resource devices 160 whenever there is a change to the shopping list 146 and/or information related to the shopping list 146 of the one or more products intended for purchase by the user. In various examples, the context handler 124 may be configured to provide dynamic adjustment to existing and available products in store inventory, which may provide transparency to the user on what to expect during physical shopping activities and which products may be specifically relevant to the user at a specific physical retailer store.

In an example, the context 132 for the user may include a profile for the user including one or more preferences related to the user defined by the user. In another example, the context 132 for the user may include a profile for the user including one or more preferences related to the user defined by one or more collaborating business entities. In various examples, the one or more preferences may include at least one of user consumption patterns, user preferences, user shopping behavior, grouping of similar products, user credit information, user buyer ratings, user value ratings, user promotional incentives, user brand loyalty, user store loyalty, general user shopping statistics, and sorting for efficient navigation within physical retailer stores. In various other examples, preferences for the user may include information related to a shopping style for the user including, for example, the products may be sorted or arranged for user based on one or more of importance of particular products, time restraints for product shopping, budget restraints for product shopping, speed of locating and purchasing products, and frugality of the user when selecting products intended for purchase.

In the example of FIG. 1, the server device 104 of the consumer activity management system 100 may include an activity manager 126 configured to cause the at least one processor 110 to manage a shopping experience for the user. For example, the activity manager 126 may be configured to manage a shopping experience for the user by monitoring one or more physical shopping activities of the user. The activity manager 126 may be configured for monitoring one or more physical shopping activities of the user within one or more physical retailer stores 190 by receiving information from one or more collaborating devices (e.g., one or more entities, such as one or more business entity devices 170 and/or one or more other user devices 180) in at least one of the physical retailer stores 190 including information (e.g., entity information, such as business entity information 172 and/or other user information 182) related to one or more products 192 available in the at least one of the physical retailer stores 190. The activity manager 126 may be configured to aggregate and/or store the entity information including the business entity information 172 and the other user information 182 in the database 130. Further, the server device 104 may be implemented as a serving communication device adapted for interfacing with the one or more business entity devices 170 (e.g., indoor, in-store, or out-of-store computing/communication devices including servers, mobile devices, smart phones, laptops, notebooks, PCs, etc.) and the one or more other user devices 180 (e.g., other user computing devices including other mobile phone devices, other smart phones, other laptops, other notebooks, other PCs, etc.) and for wireless communication over one or more networks, such as, for example, one or more mobile communication networks including WLAN, Wi-Fi, wireless telecommunication networks, etc. and the Internet. In various implementations, the business entity devices 170 may include network computing devices, such as servers, computers, databases, or any other relevant computing devices configured for communication over a network including a wireless network.

In another example, the activity manager 126 may be configured for defining a relationship 136 between the one or more products 148 of the shopping list 146 and the one or more products 192 available in the at least one of the physical retailer stores 190 corresponding to the one or more products 148 of the shopping list 146. The activity manager 126 may be configured to store relationship information 138 related to the relationship 136 between the one or more products 148 of the shopping list 146 and the one or more corresponding products 192 available in the at least one of the physical retailer stores 190 in the database 130.

In another example, the activity manager 126 may be configured for linking the relationship 136 to the context 132 for the user by providing a link 140 between the relationship 136 to the context 132 for the user. The activity manager 126 may be configured to store linking information 142 related to the linking of the relationship 136 to the context 132 for the user in the database 130 or related to the link 140 between the relationship 136 to the context 132 for the user.

For instance, in the example of FIG. 1, the database 130 may be utilized by the server device 104 to store and/or aggregate information related to the links 140 and the linking information 142 between various relevant components and information of the system 100. For instance, as shown in the database 130 of FIG. 1, the server device 104 may be configured to link and/or associate the context 132 for the user and the user context information 134 to the relationship 136 and the relationship information 138 defined between one or more of the user information 144, the shopping list 146, and the one or more products 148 of the shopping list 146, and the server device 104 may be configured to store the links 140 (and/or associations) and the related linking information 142 (and/or related association information) in the database 130.

Further, as shown in the database 130 of FIG. 1, the server device 104 may be configured to link and/or associate the context 132 for the user and the user context information 134 to the relationship 136 and the relationship information 138 defined between one or more of the resource information 162 from each of the one or more resource devices 160, the business entity information 172 from each of the one or more business entity devices 170, the other user information 182 from each of the one or more other user devices 180, and the one or more products 192 from each of the one or more physical retailer stores 190, and the server device 104 may be configured to store the links 140 (and/or associations) and the related linking information 142 (and/or related association information) in the database 130.

In another example, the activity manager 126 may be configured for aggregating information related to the physical retailer stores 190. This aggregation may include aggregating product information 192 related to each of the physical retailer stores 190 including, for example, price comparisons and multi-store comparisons for each of the products 192 for each of the physical retailer stores 190.

In another example, the activity manager 126 may be configured for presenting an overview 150 to the user via the user interface 142 of the user device 140 including the relationship information 136 and/or the linking information 138 related to the linking of the relationship to the context 132 for the user. In various examples, the overview 150 may include other information including one or more of user information 144 along with information related to the shopping list 146 and information related to the one or more products 148 of the shopping list 146, resource information 162 related to the one or more products 148 of the shopping list 146, user context information 134 related to the context 132 for the user, and entity information including the business entity information 172 and the other user information 182.

In another example, the activity manager 126 may be configured to sort the shopping list 146 based on the information related to the one or more physical shopping activities of the user and the information related to the context 132 for the user, which may include preferences for the user. For instance, preferences for the user may include information related to consumption patterns, shopping behavior, and/or shopping style for the user including, for example, sorting and/or arranging the products for user based on one or more of importance of particular products, time restraints for product shopping, budget restraints for product shopping, speed of locating and purchasing the products, and frugality of the user when selecting products for intended purchase.

In another example, the activity manager 126 may be configured to integrate the information related to the one or more physical shopping activities of the user with the information related to the context 132 for the user and present an overview of the integrated information to the user via the user device 140. In various examples, the user context information 134 may include information relevant to a specific user, at a specific location, and at a specific time. For instance, the user context information 134 may include one or more of user preferences, user consumption patterns, user shopping behavior, grouping of similar products, user credit information, promotional incentives, and sorting for efficient navigation within a physical retailer store. In another example, the user context information 134 may include information related to a shopping style for the user including the product preferences sorted or arranged based on importance of particular products, time constraints for product shopping, budget restraints for product shopping, speed of locating and purchasing the products, and frugality of the user when selecting products intended for purchase.

In another example, the one or more collaborating devices may include one or more external devices in collaboration with one or more entities including at least one of one or more business entities 170 and one or more other users 180. The activity manager 126 may be configured to maintain the context 132 for the user in collaboration with the one or more entities including at least one of one or more business entities 170 and one or more other users 180. The information from the one or more collaborating devices (e.g., the business entity information 172 and/or the other user information 182) may include information related to product location information within the at least one physical retailer store. Further, the server device 104 may be implemented as a serving communication device adapted for interfacing with the one or more collaborating devices (e.g., one or more in-store or out-of-store computing/communication devices and one or more other mobile smart phone devices) and for wireless communication over one or more networks within the physical retailer store 190 for indoor user navigation, such as, for example, one or more mobile communication networks including WLAN, Wi-Fi, etc. and the Internet. In various implementations, the server device 104 may be configured to communicate with the collaborating devices directly or via the user device 140, which may occur in a mobile, cloud based network across one or more stores.

In another example, the activity manager 126 may be configured to provide the user with a product location overview including a map of the physical retailer store 190 with product placement information including product markers for locating the one or more products 192 available in the at least one physical retailer store at their specific place in the store 190 corresponding to the one or more products 148 of the shopping list 146. For instance, the activity manager 126 may utilize retail knowledge information provided by the physical retailer store 190 including store layout information (e.g., digital landscape information of product layout, shelf layout, storage layout, and/or some other related layout within the specific store) made known by the physical retailer store 190 to thereby optimize the shopping experience for the user. Further, the physical retailer store 190 may be motivated to provide the product layout information so as to increase product sales. In various examples, optimizing the shopping experience for the user may include determining which products the user plans or intends to purchase and/or determining which products are actually physically placed in the user's shopping cart or basket during physical shopping activities of the user.

In another example, the activity manager 126 may be configured to assign the at least one physical retailer store to one or more products on the shopping list 146 based on the context 132 for the user. For instance, when a physical shopping activity is started, the user may manually assign the shopping list 146 to a specific physical retailer store, or the user may allow the server device 104 to assign the shopping list 146 to a specific physical retailer store. In various implementations, the server device 104 may be configured to automatically assign, attach, or associate the shopping list 146 to a specific physical retailer store when the user enters the store.

In various implementations, one or more of the resources devices 160, the business entity devices 170, and the other user devices 180 may be related to one or more of the physical retailer stores 190. For instance, one or more of the devices 160, 170, 180 may be provided by and/or may be located within one or more of the physical retailer stores 190 when interfacing with the server device 104. In another instance, the user and the user device 140 may be located within at least one of the physical retailer stores 190 along with one or more of the devices 160, 170, 180 when interfacing with the server device 104. In still another instance, the server device 104 may be located within at least one of the physical retailer stores 190 along with one or more of the devices 140, 160, 170, 180 when interfacing with the server device 104.

In various implementations, the server device 104 may be configured for transmitting and receiving wireless communications signals to and from the other system components 130, 140, 160, 170, 180, 190 over a wireless network including a wireless indoor navigation network via any wireless communications technologies and protocols including radio frequency (RF), microwave frequency (MWF), and/or infrared frequency (IRF) wireless communications technologies and protocols adapted for communication over a network. Similarly, the user device 140 and collaborating devices (e.g., resource devices 160, business entity devices 170, other user devices 180, and any collaborating devices within the physical retailer stores 190) may be configured for transmitting and receiving wireless communications signals to and from the server device 104 via any wireless communications technologies and protocols including RF, MWF, and/or IRF wireless communications technologies and protocols adapted for communication over a wireless network including a wireless indoor navigation network.

In the example of FIG. 1, the system 100 may be used for connecting the shopping list 146 to indoor navigation features across one or more physical retailer stores 190. In various implementations, the shopping list 146 may be referred to as a mobile, cloud-based shopping list connected to indoor navigation across multiple stores. Further, the server device 104 may be configured to utilize the shopping list 146 to link analog shopping activities of the user to contextualized, digital information related to the user for improving user shopping experiences. For instance, a user may create the shopping list 146 in a mobile application (e.g., user interface 142) of the user device 140 (e.g., mobile smart phone) based on user voice input, user free text input, user selection from existing product catalog, etc. In various implementations, this may be achieved with or without any relation to a specific retailer store and/or brand. Once a shopping activity is started, the user may manually assign the shopping list 146 to a specific physical retailer store, or the user may allow the server device 104 via the application to automatically assign a specific physical retailer store when the user physically enters the store.

Further, in the example, of FIG. 1, when this association has been made, one or more of the following may occur. For example, the shopping list 146 may be automatically sorted after certain criteria including a context for the user, one or more of user preferences, grouping of similar items/products (grocery together, dairy together), sorting for efficient navigation within the store (to minimize time needed to locate and collect one, some, most, or all items of the shopping list), etc. In another example, the items/products of the shopping list 146 may be mapped or automatically mapped from a generic term (e.g., milk) to a specific product description/terminology of a specific store (e.g., store brand milk with any related description). This may occur or happen based on one or more of user preferences, user consumption patterns, user shopping behavior, user profile information, item/product catalog of the retailer, product availability, product inventory, or some combination thereof. In another example, for each item/product, an availability may be indicated to the user, and in case of non-available items/products, possible alternatives may be suggested to the user. In another example, the user may be provided with an overview (e.g., map with place markers) for locating the items/products of the shopping list 146 at their specific place in the store (e.g., aisle, shelf, position).

Further, in the example, of FIG. 1, if items/products of the shopping list 146 have not been purchased after leaving the physical store, the server device 104 via the application may suggest one or more other physical stores where the user may be able to purchase the remaining items/products. In another example, along with the application on the mobile device, a cloud based component may be implemented to collect data and information from distributed data sources/resources and orchestrate processes.

Hence, aspects of the disclosure provide for combining available digital information into a user shopping experience to support physical shopping activities for the user. The digital information may include one or more of user/consumer context, store layout maps, in-store product layout, product descriptions, product categories, product availability, product inventory, user/consumer preferences, user/consumer loyalty profiles from retailer databases, and promotional benefits, and loyalty programs. Further, aspects of the disclosure provide solutions that cover individual aspects of the problem space including collaborating with business entities, company entities, retailer entities, brand entities, other user entities, etc. Accordingly, aspects of the disclosure provide for harmonizing shopping experiences for the user/consumer across a range of systems and processes related to bringing together shopper utility and retailer marketing. Further, aspects of the disclosure provide for dynamic adjustment to existing physical inventory and available goods/items/products/services in stock, which may provide transparency to the user/consumer on shopping expectations and store inventory specifically relevant for the user/consumer at specific physical stores. In any event, the features mentioned herein may be configured to provide store/brand diagnostics for assisting the user/consumer to make informed decisions for physical shopping activities.

As such, the consumer activity management system 100 of FIG. 1 (in particular, the activity manager 126) may be configured to provide an optimal or at least near-optimal consumer shopping activity solution to manage a shopping experience for a consumer, in a quick, efficient, and reliable manner. The system 100 may be configured to model associations of possible shopping activities (e.g., product availability, product location, product relevance, product purchasing benefits), as well as associated “what-if” scenario modeling of possible shopping activities that may allow for informed decisions about everyday shopping practices and transactions.

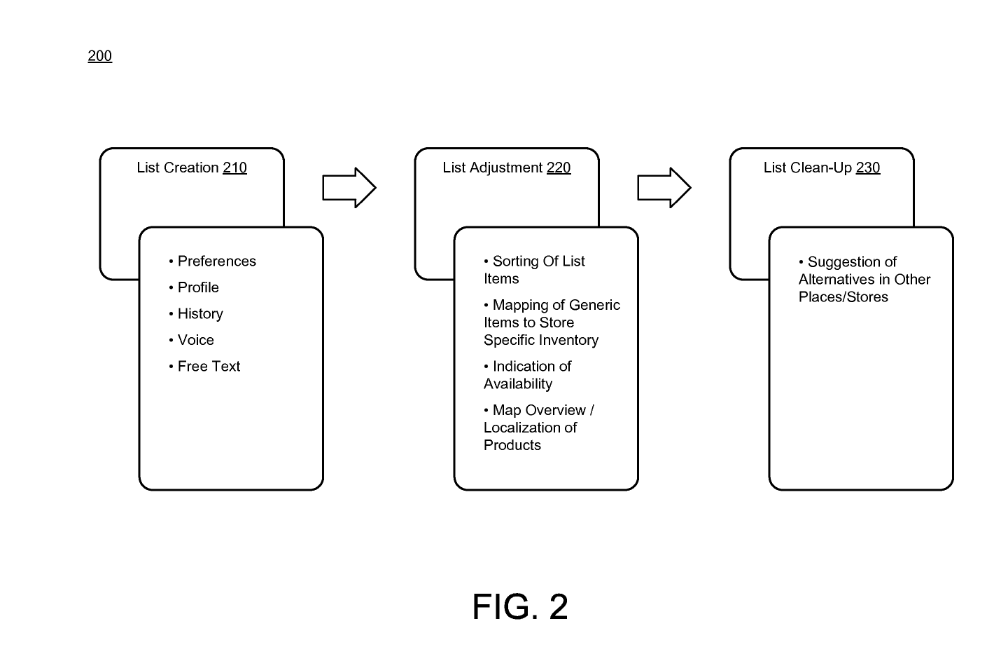

FIG. 2 is a block diagram illustrating an example process flow 200 for managing consumer activity, in accordance with aspects of the disclosure.

In the example of FIG. 2, the process flow 200 may include list creation 210 for creating a list, such as, for example, creating a shopping list including the shopping list 146 as described in reference to FIG. 1. The shopping list may include one or more products intended for purchase by the user. Further, the user may create the shopping list in a mobile application (e.g., user interface of FIG. 1) based on various input parameters by the user, such as, for example, user free text input, user voice input, user selection from existing product catalog, etc. The shopping list may include a list of one or more items, products, and/or services intended for purchase by the user. As such, the one or more products of the shopping list may refer and/or include one or more items and/or services intended for purchase by the user.

The shopping list may be associated with a context for the user, such as the context 132 of FIG. 1. In various implementations, the shopping list created by the user and/or the context for the user may be associated with a profile for the user including one or more preferences related to the user defined by the user and/or in collaboration with one or more business entities. In various examples, the profile and/or preferences may include information related to at least one of user preferences, grouping of similar products, and sorting for efficient navigation within a physical retailer store. Further, the profile and/or preferences may include information related to user purchase history, user shopping behavior, user consumption patterns, product preferences, product categories, product related alternatives, product promotions, product purchase incentives, retailer layout maps, store layout maps, and retailer related user information including loyalty benefits and user records including any information related to the user.

In the example of FIG. 2, the process flow 200 may include list adjustment 220 for adjusting the list, such as, for example, adjusting the shopping list including the shopping list 146 as described in reference to FIG. 1. For example, the shopping list may be adjusted (including automatically adjusted) by sorting the list items and/or products based on certain criteria. In various examples, this adjustment may include implementing various user preferences, user context information, grouping of similar items (grocery together, dairy together), and sorting for most efficient navigation within the store (to minimize time needed to collect one or more of the products).

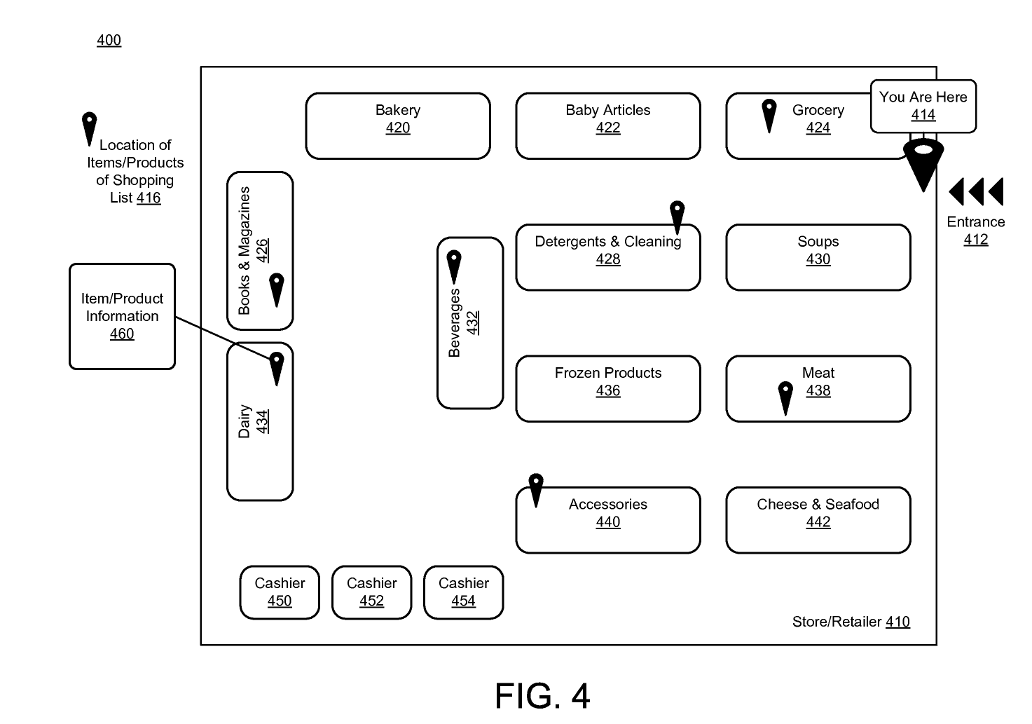

In another example, the shopping list may be adjusted by mapping of generic items and/or products to store specific inventory. For example, the products of the shopping list may be mapped (including automatically mapped) from a generic term (e.g., milk, cheese, bread, etc.) to a specific description and/or terminology related to a specific store (e.g., store branded milk, cheese, bread, etc. and related description thereto). In various examples, this mapping may happen or occur based on user context information, user preferences, user consumption patterns, user shopping behavior, user shopping style, user profile information, product catalog of the retailer, or some combination thereof. As shown in FIG. 4, the user may be provided with an overview (e.g., visual map with place markers) to assist the user with finding and/or locating the one or more products of the shopping list at their specific place or location within the physical retailer store (e.g., aisle, shelf, position, etc.).

In another example, the shopping list may be adjusted when the shopping list is associated to a specific physical retailer store. In some examples, when a physical shopping activity has been initiated, the user may either manually assign the shopping list to a specific physical retailer store or allow the server device 104 to automatically attach to a physical retailer store once the user enters the store. In various examples, once an association has been made between the user's shopping list and at least one physical retailer store, adjustment to the shopping list may include sorting of the products of the shopping list, mapping of generic products to specific inventory of the specific physical retailer store, indicating availability of products of the specific physical retailer store, and providing an overview map and localization of the products available within the specific physical retailer store. In some examples, this may be achieved via communication with one or more collaborating devices from within the physical retailer store.

In the example of FIG. 2, the process flow 200 may include list clean-up 230 for cleaning-up a list, such as, for example, cleaning-up the shopping list including the shopping list 146 as described in reference to FIG. 1. In an example, an availability may be indicated for each of the products of the shopping list. In case of non-available products, lack of inventory, out-of-stock products, missing products, no longer available products, possible alternatives may be suggested in and out of the current physical retailer store. In another example, if products remain on the shopping list after leaving the physical retailer store, the server device 104 may suggest one or more other physical retailer stores where the user may be able to purchase the remaining products from the shopping list that have not been purchased yet. Along with an application on a mobile device, a cloud based component may be implemented to collect relevant information from distributed data sources and orchestrate processes.

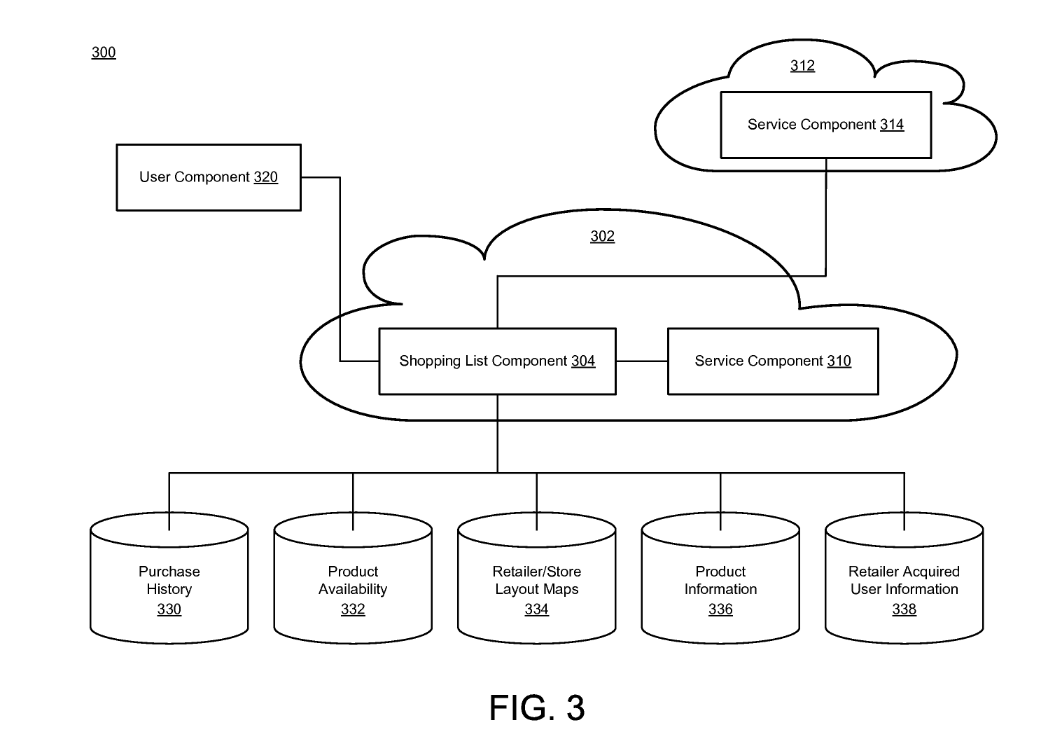

FIG. 3 is a block diagram illustrating an example cloud-based system 300 for managing consumer activity, in accordance with aspects of the disclosure.

In the example of FIG. 3, various components of the system 100 of FIG. 1 may be associated with the cloud-based system 300 for managing consumer activity in a manner as provided herein. Generally, cloud computing utilizes computing resources of a network, such as hardware and software, that may be delivered as a service over a network (e.g., the Internet). Further, cloud computing may entrust remote services with user related information, software, and computation. For reference, the cloud-shaped symbol in FIG. 3 may be referred to as an abstraction for infrastructure related to cloud-based systems. In collaboration with a user application on a mobile user device, a cloud-based component may be implemented to collect information from distributed data sources and orchestrate processes.

For instance, in the example of FIG. 3, within a cloud 302, a shopping list component 304 may be configured for receiving information from a user via a user component 320 including a shopping list of one or more products intended for purchase by the user. From the cloud 302, the shopping list component 304 may be configured for retrieving information from one or more resource components 330, 332, 334, 336, 338 including information related to the one or more products of the shopping list. In an implementation, the one or more resources may include purchase history resource 330, product availability resource 332, retailer/store layout maps resource 334, product information resource 336, and retailer acquired user information resource 338. In other implementations, other resources may be used by the shopping list component 304.

Further, in the example of FIG. 3, the shopping list component 304 may be configured for deriving and maintaining a context for the user based on the information received from the user component 320 and the information retrieved from the one or more resource components 330, 332, 334, 336, 338. The shopping list component 304 may be configured for managing a shopping experience for the user by use of process orchestration and data/information integration including logic to provide services across multiple stores, shops, vendors, retailers, etc. For instance, the shopping list component 304 may be configured for monitoring one or more physical shopping activities of the user by receiving information from one or more collaborating devices in one or more physical retailer stores including information related to one or more products available in the one or more physical retailer stores.

Further, in the example of FIG. 3, the shopping list component 304 may be configured for defining a relationship between the one or more products of the shopping list and the one or more products available in the one or more physical retailer stores corresponding to the one or more products of the shopping list. The shopping list component 304 may be configured for linking the relationship to the context for the user and presenting an overview (e.g., a visual map marking one or more products from the shopping list that are specifically available in at least one of the physical retailer stores) to the user via the user component 320. In some examples, the overview may include information related to the linking of the relationship to the context for the user.

In another example, the shopping list component 304 may be configured for interfacing with an additional service component 310 from within the cloud 302. The service component 310 may be configured to provide the shopping list component 304 with additional services including, for example, promotion based information from one or more precision retailing information providers.

In another example, the shopping list component 304 may be configured for interfacing with another additional service component 314 from one or more other clouds 312. The service component 314 may be configured to provide the shopping list component 304 with additional services including, for example, speech-to-text based services from one or more speech-to-text service providers.

In an implementation, the shopping list component 304 may be configured with similar scope, function, and/or operation of the server device 104 as described in reference to FIG. 1. Further, in another implementation, the user component 320 may be configured with similar scope, function, and/or operation of the user device 140 of FIG. 1, and the resource components 330, 332, 334, 336, 338 may be configured with similar scope, function, and/or operation of the resource devices 160 of FIG. 1.

FIG. 4 is a diagram illustrating an example overview 400 for providing the user with product location information within a physical retailer store 410, in accordance with aspects of the disclosure.

In an example, the user may be provided with the overview 400 including a product location overview including a mapping of the physical retailer store 410 with product information 460 including product placement information and product markers 416 for locating the one or more products available in the at least one physical retailer store 410 at their specific place in the store 410 corresponding to the one or more products of the shopping list 146. The product information 460 may include one or more products of the shopping list that are mapped from a generic term (e.g., milk) to a specific product description and/or terminology of the physical retailer store 410 (e.g., specific store brand milk with related description). In various examples, this mapping may occur based on one or more of user context information, user profile information, user preference information, user consumption information, user shopping behavior, product catalog of the retailer, etc., or some combination thereof.

In various examples, the overview 400 may include an indication 412 of a position of an entrance to the physical retailer store 410. The overview 400 may include an indication 414 of a position of the user, and the indicator 414 may follow and/or track the user in the overview 400 as the user moves within the physical retailer store 410. The overview 400 may include an indication 450, 452, 454 of a position of one or more cashiers including cashier terminals and point of sale (POS) devices.

In an example, referring to FIG. 1, the one or more products 148 of the shopping list 146 may correspond to one or more products 192 in the physical retailer store 190. Further, in another example, product categories may include one or more of bakery 420, baby articles 422, grocery 424, books and magazines 426 detergents and cleaning 428, soups 430, beverages 432, dairy 434, frozen products 436, meat 438, accessories 440, and cheese and seafood 442. In various examples, product categories should not be limited to these examples, and as such, product categories may include any relevant product category or categories that may be normally and/or regularly used in retail practices and in physical retailer stores.

In another example, in-store navigation or indoor navigation may be achieved across multiple stores (i.e., physical retailer stores) and further realized using a combination of location features, such as, for example, geographical coordinates, global positioning system (GPS), indoor WiFi, infrared frequency (IRF) techniques, pattern tile, radio frequency (RF) techniques, radio frequency identification (RFID), etc.

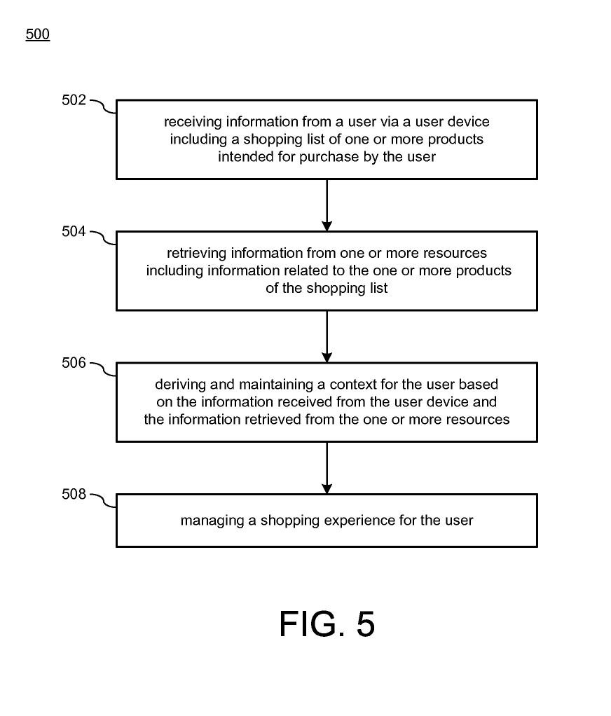

FIG. 5 is a process flow illustrating an example method 500 for managing consumer activity, in accordance with aspects of the disclosure.

In the example of FIG. 5, operations 502-508 are illustrated as discrete operations occurring in sequential order. However, it should be appreciated that, in other implementations, two or more of the operations 502-508 may occur in a partially or completely overlapping or parallel manner, or in a nested or looped manner, or may occur in a different order than that shown. Further, additional operations, that may not be specifically illustrated in FIG. 5, may also be included in some implementations, while, in other implementations, one or more of the operations 502-508 may be omitted.

Further, in the example of FIG. 5, the method 500 may include a process flow for a computer-implemented method for managing consumer activity in the system 100 of FIG. 1. As described herein, the operations 502-508 are configured to provide a simplified operational process flow that may be enacted by the server device 104 to provide features and functionalities as described in reference to FIG. 1.

In an aspect of the disclosure, the method 500 is provided for managing consumer activity. In the example of FIG. 5, at 502, the method 500 may include receiving information from a user via a user device including a shopping list of one or more products intended for purchase by the user. The information received from the user may include user input information acquired from the user by the user device.

At 504, the method 500 may include retrieving information from one or more resources and/or resource devices including information related to the one or more products of the shopping list. In an example, the one or more resources may include one or more internal resources including locally stored information related to the one or more products of the shopping list. In another example, the one or more resources may include one or more external resources including remotely stored information related to the one or more products of the shopping list. In various examples, the one or more resources may include information related to one or more of user purchase history, product availability, product information, product categories, product related alternatives, product promotions, product purchase incentives, retailer/store layout maps, product cataloging, and retailer acquired user information including loyalty benefits and user records.

At 506, the method 500 may include deriving and maintaining a context for the user based on the information received from the user device and the information retrieved from the one or more resources. In an example, maintaining the context for the user may include dynamically updating information related to the user and dynamically updating information related to the one or more resources whenever there is a change to the shopping list of the one or more products intended for purchase by the user.

In another example, the context for the user may include a profile for the user including one or more preferences related to the user defined by the user. The one or more preferences may include at least one of user preferences, grouping of similar products, and/or sorting for efficient navigation within a physical retailer store.

In another example, the context for the user may include a profile for the user including one or more preferences related to the user defined by one or more collaborating business entities. The one or more preferences may include at least one of user preferences, grouping of similar products, and/or sorting for efficient navigation within a physical retailer store.

At 508, the method 500 may include managing a shopping experience for the user. In an example, managing the shopping experience for the user may include linking analog shopping activities to contextualized, digital information for a better user shopping experience. In another example, managing the shopping experience for the user may include combining available digital information into a single user experience to support consumer shopping activities. The digital information may include store layout maps, product information including product categories, product availability, consumer preferences, consumer loyalty profiles from retailer databases, promotional information for products, etc. In another example, managing the shopping experience for the user may include harmonizing and/or integrating collaborating entities (e.g., resource entities, business entities, other users, physical retailer stores, etc.) for the user to bring together shopper utility and retailer marketing. In another example, managing the shopping experience for the user may include dynamically adjusting product data and information to existing inventory and/or available goods in stock. This may provide transparency to the user on what to expect and which item/product is specifically relevant for the user's needs at this specific store. The features may provide shop/brand diagnostic assistance to the user to make purchasing decisions considering different shops and/or different products from different vendors. In another example, managing the shopping experience for the user may include providing mechanisms that support users/shoppers in finding their desired items/products efficiently as indoor navigation capabilities (e.g., aisle, shelf, place) within a physical retailer store.

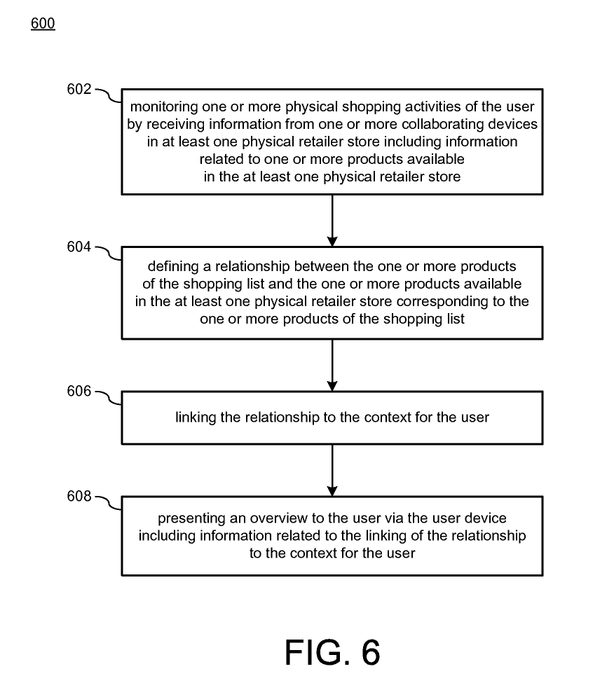

FIG. 6 is a process flow illustrating another example method 600 for managing consumer activity, in accordance with aspects of the disclosure.

In the example of FIG. 6, operations 602-608 are illustrated as discrete operations occurring in sequential order. However, it should be appreciated that, in other implementations, two or more of the operations 602-608 may occur in a partially or completely overlapping or parallel manner, or in a nested or looped manner, or may occur in a different order than that shown. Further, additional operations, that may not be specifically illustrated in FIG. 6, may also be included in some implementations, while, in other implementations, one or more of the operations 602-608 may be omitted.

Further, in the example of FIG. 6, the method 600 may include a process flow for a computer-implemented method for managing consumer activity in the system 100 of FIG. 1. As described herein, the operations 602-608 are configured to provide a simplified operational process flow that may be enacted by the server device 104 to provide features and functionalities as described in reference to FIG. 1.

In an aspect of the disclosure, the method 600 is provided for managing a shopping experience for the user. In the example of FIG. 6, at 602, the method 600 may include monitoring one or more physical shopping activities of the user by receiving information from one or more collaborating devices in at least one physical retailer store including information related to one or more products available in the at least one physical retailer store. In an example, the one or more collaborating devices may include one or more external devices in collaboration with one or more entities including at least one of one or more resources, one or more business entities, one or more other users, one or more collaborating devices in one or more physical retailer stores, etc. In another example, managing a shopping experience for the user may include maintaining the context for the user in collaboration with the one or more entities. In another example, the information from the one or more collaborating devices may include information related to product location information within the at least one physical retailer store.

At 604, the method 600 may include defining a relationship between the one or more products of the shopping list and the one or more products available in the at least one physical retailer store corresponding to the one or more products of the shopping list. In an example, the method 600 may define various relationships between one or more items/products on the shopping list of intended purchases by the user and one or more of the items/products that are available in a physical retailer store.

At 606, the method 600 may include linking the relationship to the context for the user. In an example, the method 600 may link one or more analog shopping activities to contextualized, digital information for managing shopping experiences for the user. For instance, the user may create or generate the shopping list in a mobile application (e.g., user interface 142) of the user device 140 based on one or more of voice input, free text input, selection from existing product catalog, etc. This may be achieved without any relation to a specific store/brand. Once shopping is started, the user may manually assign a list to a specific store or allow the application to automatically attach to a physical retailer store once the user enters the physical retailer store.

At 608, the method 600 may include presenting an overview to the user via the user device including information related to the linking of the relationship to the context for the user. In an example, presenting the overview to the user via the user device may include providing the user with a product location overview including a map of the physical retailer store with product placement information including product markers for locating the one or more products available in the at least one physical retailer store at their specific place in the store corresponding to the one or more products of the shopping list.

In an implementation, the method 600 may include sorting the shopping list based on the information related to the one or more physical shopping activities of the user and the information related to the context for the user. The method 600 may include integrating the information related to the one or more physical shopping activities of the user with the information related to the context for the user and present an overview of the integrated information to the user via the user device. The method 600 may include assigning the at least one physical retailer store to one or more products on the shopping list based on the context for the user.

In another implementation, when product associations or relationships are defined, the shopping list may be automatically sorted after certain criteria including user preferences, grouping of similar items (e.g., grocery together, dairy together), sorting for efficient navigation within the store (e.g., to reduce or minimize time needed to collect one or more of the items/products of the shopping list). The items/products of the shopping list may be automatically mapped from a generic term (e.g. milk) to a specific product description/terminology of the store (e.g., store brand name for milk, type of milk, etc.). In some examples, this may happen or occur based on user preferences, user profile data, product catalog of a retailer/store, or some combination thereof. Further, for each of the items/products, an availability may be indicated. In case of non-available items/products, possible alternatives may be suggested to the user. Further, the user may be provided with an overview (e.g., map with place markers) so that the user may be able to find the items/products of the shopping list at a specific place or physical location in the physical retailer store (e.g., aisle, shelf, position, etc.).

Implementations of the various exemplary techniques as described herein may be implemented in digital electronic circuitry, or in computer hardware, firmware, software, or in various combinations of thereof. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, may be written in any form of programming language, including compiled or interpreted languages, and may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor may receive data and instructions from a read-only memory or a random access memory or both. Elements of a computer may include at least one processor for executing instructions and one or more memory devices for storing instructions and data. Generally, a computer may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for user interaction, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other types of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of networks, such as communication networks, may include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer system including instructions recorded on a non-transitory computer-readable medium and executable by at least one processor, the system comprising:
an interface handler configured to cause the at least one processor to receive information from a user via a user device including a shopping list of one or more products intended for purchase by the user;
a resource handler configured to cause the at least one processor to retrieve information from one or more resources including information related to the one or more products of the shopping list;
a context handler configured to cause the at least one processor to derive and maintain a context for the user based on the information received from the user device and the information retrieved from the one or more resources; and
an activity manager configured to cause the at least one processor to manage a shopping experience for the user by:
monitoring one or more physical shopping activities of the user by receiving information from one or more collaborating devices in at least one physical retailer store including information related to one or more products available in the at least one physical retailer store,
defining a relationship between the one or more products of the shopping list and the one or more products available in the at least one physical retailer store corresponding to the one or more products of the shopping list,
linking the relationship to the context for the user, and
presenting an overview to the user via the user device including information related to the linking of the relationship to the context for the user.

2. The system of claim 1, wherein the information received from the user includes user input information acquired from the user by the user device.

3. The system of claim 1, wherein the one or more resources include one or more internal resources including locally stored information related to the one or more products of the shopping list.

4. The system of claim 1, wherein the one or more resources include one or more external resources including remotely stored information related to the one or more products of the shopping list.

5. The system of claim 1, wherein the one or more resources include information related to one or more of user purchase history, product availability, product information, product categories, product related alternatives, product promotions, product purchase incentives, retailer layout maps, product cataloging, and retailer acquired user information including loyalty benefits and user records.

6. The system of claim 1, wherein the context handler is further configured to maintain the context for the user by dynamically updating the information related to the user and dynamically updating the information related to the one or more resources whenever there is a change to the shopping list of the one or more products intended for purchase by the user.

7. The system of claim 1, wherein the activity manager is further configured to:
sort the shopping list based on the information related to the one or more physical shopping activities of the user and the information related to the context for the user, and
integrate the information related to the one or more physical shopping activities of the user with the information related to the context for the user and present an overview of the integrated information to the user via the user device.

8. The system of claim 1, wherein the one or more collaborating devices include one or more external devices in collaboration with one or more entities including at least one of one or more business entities and one or more other users, and the activity manager is further configured to maintain the context for the user in collaboration with the one or more entities.

9. The system of claim 1, wherein the context for the user includes a profile for the user including one or more preferences related to the user defined by the user, the one or more preferences including at least one of user preferences, grouping of similar products, and sorting for efficient navigation within a physical retailer store.

10. The system of claim 1, wherein the context for the user includes a profile for the user including one or more preferences related to the user defined by one or more collaborating business entities, the one or more preferences including at least one of user preferences, grouping of similar products, and sorting for efficient navigation within a physical retailer store.

11. The system of claim 1, wherein the information from the one or more collaborating devices includes information related to product location information within the at least one physical retailer store.

12. The system of claim 11, wherein the activity manager is further configured to provide the user with a product location overview including a map of the physical retailer store with product placement information including product markers for locating the one or more products available in the at least one physical retailer store at their specific place in the store corresponding to the one or more products of the shopping list.

13. The system of claim 11, wherein the activity manager is further configured to assign the at least one physical retailer store to one or more products on the shopping list based on the context for the user.

14. The system of claim 1, wherein the system comprises a server, and the user device comprises at least one of a mobile phone, a tablet, and a laptop.

15. A computer-implemented method, comprising:
receiving information from a user via a user device including a shopping list of one or more products intended for purchase by the user;
retrieving information from one or more resources including information related to the one or more products of the shopping list;
deriving and maintaining a context for the user based on the information received from the user device and the information retrieved from the one or more resources;
managing a shopping experience for the user by:
monitoring one or more physical shopping activities of the user by receiving information from one or more collaborating devices in at least one physical retailer store including information related to one or more products available in the at least one physical retailer store,
defining a relationship between the one or more products of the shopping list and the one or more products available in the at least one physical retailer store corresponding to the one or more products of the shopping list,
linking the relationship to the context for the user, and
presenting an overview to the user via the user device including information related to the linking of the relationship to the context for the user.

16. The method of claim 15, wherein the context for the user includes a profile for the user including one or more preferences related to the user defined by at least one of the user and one or more collaborating business entities, the one or more preferences including at least one of user preferences, grouping of similar products, and sorting for efficient navigation within a physical retailer store.

17. The method of claim 15, further comprising presenting the user with a product location overview including a map of the physical retailer store with product placement information including product markers for locating the one or more products available in the at least one physical retailer store at their specific place in the store corresponding to the one or more products of the shopping list.

18. A computer program product, the computer program product being tangibly embodied on a non-transitory computer-readable medium and comprising instructions that, when executed by at least one processor, are configured to:
receive information from a user via a user device including a shopping list of one or more products intended for purchase by the user;
retrieve information from one or more resources including information related to the one or more products of the shopping list;
derive and maintain a context for the user based on the information received from the user device and the information retrieved from the one or more resources;
manage a shopping experience for the user by:
monitoring one or more physical shopping activities of the user by receiving information from one or more collaborating devices in at least one physical retailer store including information related to one or more products available in the at least one physical retailer store,
defining a relationship between the one or more products of the shopping list and the one or more products available in the at least one physical retailer store corresponding to the one or more products of the shopping list,
linking the relationship to the context for the user, and
presenting an overview to the user via the user device including information related to the linking of the relationship to the context for the user.

19. The computer program product of claim 18, wherein the context for the user includes a profile for the user including one or more preferences related to the user defined by at least one of the user and one or more collaborating business entities, the one or more preferences including at least one of user preferences, grouping of similar products, and sorting for efficient navigation within a physical retailer store.

20. The computer program product of claim 18, further comprising presenting the user with a product location overview including a map of the physical retailer store with product placement information including product markers for locating the one or more products available in the at least one physical retailer store at their specific place in the store corresponding to the one or more products of the shopping list.
